(19) United States
(12) Patent Application Publication
(10) Pub. No.: US 2014/0319066 A1
(43) Pub. Date: Oct. 30, 2014

(54) Thin Stillage Clarification

(71) Applicant: Yield and Capacity Group, LLC, Clear Lake, IA (US)

(72) Inventors: Michael B. LoCascio, Clear Lake, IA (US); Ronald K. Dunbar, Canyon, TX (US)

(73) Assignee: Yield and Capacity Group, LLC, Clear Lake, IA (US)

(21) Appl. No.: 14/222,678

(22) Filed: Mar. 23, 2014

Related U.S. Application Data
(60) Provisional application No. 61/804,641, filed on Mar. 23, 2013.

(51) Int. Cl. C02F 1/38; C02F 1/56; C12F 3/10; C02F 1/44

(52) U.S. Cl. CPC C02F 1/385; C02F 1/44; C02F 1/56; C12F 3/10
USPC 210/710; 210/202; 210/732; 210/734; 210/712

(57) ABSTRACT

Systems and methods for improving the quality of solids and liquids recovered at atmospheric pressure and temperature from a stillage stream generated as a by-product of an ethanol production process, the recovered solids having higher bio-available amino and fatty acids than evaporation-produced condensed solubles, the recovered liquids having less total solids and total suspended solids than evaporation-produced condensate. A static mixer includes an input for receiving the stillage stream combined with a GRAS anionic polymer, a cylindrical mixing chamber that controllably mixes the stillage stream and the polymer to generate wet flocculated solids and liquid co-product, and a discharge chute that outputs the wet flocculated solids and liquid co-products onto a moving, gravity filter belt having a membrane surface that separates the output from the static mixer into recovered liquids in the form of clarified, thin stillage and recovered solids in the form of dry flocculated solids.

### CROSS REFERENCE TO RELATED APPLICATIONS

This patent application claims priority benefit under 35 U.S.C. §119(e) of U.S. Prov. Pat. Appl. No. 61/804,641, entitled “Thin Stillage Clarification in Grain Alcohol Production,” filed Mar. 23, 2013, which is incorporated herein by reference in its entirety.

### FIELD OF THE PRESENT INVENTION

The present invention relates generally to processes and systems for producing grain alcohols, such as ethanol, and, more particularly, to improved methods and systems for efficiently processing, recovering, and recycling the by-products and co-products generated during the grain alcohol production process.

### BACKGROUND OF THE PRESENT INVENTION

Although it can be used for many purposes, alcohol represents a renewable and clean fuel source. A grain alcohol commonly used as a fuel source is ethanol, which can be produced, in large part, from corn or other grain feedstock by the fermentation of starch. Generally, grain alcohol or ethanol (hereinafter, the terms “alcohol” and “ethanol” shall be referred to interchangeably) production is accomplished through a fermentation and distillation process in which starches are released from the processed grain and converted into sugars. The sugars are then converted to alcohol by the addition of yeast. The alcohol is then typically recovered using a distillation process. At an industrial level, ethanol production processes only convert about one-third of the original grain feedstock into ethanol.

Because two-thirds of the original grain feedstock is not convertible into ethanol, the handling, recovery, and re-use of the various by-products, co-products, and “waste” products of the ethanol production process represent a significant source of additional value and/or cost savings that are available to ethanol production facilities. Extracting additional value from the grain feedstock used, as well as reducing energy and raw material consumption required by the ethanol production process, can have a significant positive financial impact on the industry's economic viability and, when employed within an ethanol production facility, can provide substantial financial returns for the facility beyond just the value of the ethanol that is produced.

Numerous processes and systems have been developed to recover by-products and co-products that remain after ethanol is generated during the grain alcohol production process. Such by-products and co-products include, for example, wet distillers grains with solubles (WDGS) and dry distillers grains with solubles (DDGS), which include the portion of the grain feedstock, such as germ, protein, gluten, hull, and carbohydrates, which remain after distillation. wet distillers grains with solubles (WDGS) and dry distillers grains with solubles (DDGS) actually have value and can be sold as animal feedstock or as additives to other animal feedstock. Additionally, processes and systems exist to recover and extract water from the portions of the grain feedstock that remain after distillation, which can then be recycled for use at the front end of the ethanol production process. Yet further, processes and systems have also been developed to recover oils from the portions of the grain feedstock that remain after distillation.

Despite such existing processes and systems for handling, recovering, re-using, and recycling the various by-products and co-products of the ethanol production process, there still remain significant opportunities in the grain alcohol production industry for maximizing even further the value achievable from every bushel of grain feedstock processed.

For example, there is a need in the industry for improving the production capacity of ethanol production facilities by lowering the amount of total solids (TS) and total suspended solids (TSS) in the thin or thick stillage, which are intermediary by-products created after ethanol is generated during the grain alcohol production process. When thin stillage is returned to the front of the ethanol production process and introduced into the fermentation process, it is called backset. Production facilities are limited in the amount of backset that can be recycled due to the high levels of total solids (TS) and total suspended solids (TSS) present in it. As the percentage of backset increases, the viscosity of the fermentation liquids increase and put strain on the yeast, which lowers alcohol yields. The high viscosity also greatly increases the pumping energy required and increases the fouling characteristics in the heat exchangers, which again increases the cooling load on the production facility, which translates into greater energy demand necessary to process the alcohol.

Reducing the total solids (TS) and total suspended solids (TSS) in the backset allows an ethanol production facility to increase the percentage of backset without increasing the viscosity. Increasing the amount of backset also reduces fresh water demands and lowers the energy requirements of such production facilities. Reducing the viscosity also has the significant benefit of improving the fermentation environment (i.e., lowering the osmotic stress on the yeast used in the fermentation process of the production facility). Lowering the osmotic stress on the yeast is likely to increase alcohol production and yield of ethanol production facilities.

The total solids (TS) and total suspended solids (TSS) that would be removed contain, predominantly, C-5 sugars, lignins, etc., and are considered to be non fermentable; thus, the presence of total solids (TS) and total suspended solids (TSS) in conventional backset reduces the amount of fermentable starch and sugar that can be processed in each batch of corn/grain feedstock input into the ethanol production facility, which reduces the ethanol output of the facility. On the other hand, if it is possible to remove or significantly reduce the amount of total solids (TS) and total suspended solids (TSS) in the backset, there would be additional capacity for starch (additional corn/grain feedstock) to be added without increasing the viscosity to the point of causing heat exchanger fouling or increasing the pumping energy requirements. There is a direct correlation between the amounts of additional starch (overall capacity increase for the ethanol production facility) and reductions of total solids (TS) and total suspended solids (TSS) in the backset.

There is thus a need and an opportunity to increase the ethanol production capacity of a facility by up to 4%. There is a further need and opportunity to achieve such production increases while also reducing the amount of water (per gallon of ethanol produced) required by an ethanol production facility. Increasing the amount of backset that can be used effectively on the front end of the ethanol production process ideally reduces the amount of fresh water required for each fermentation cycle.

There is a further need and opportunity to extract a greater percentage of bio-oil, such as corn oil, from the by-products generated during the ethanol production process.

The above needs, opportunities, and features are disclosed herein or will become readily apparent to one of ordinary skill in the art after reading and studying the following summary of the present inventions, the detailed description of preferred embodiments, and the claims included hereinafter, which disclose technologies, systems, and processes that further improve the handling, recovery, and recycling of the various by-products and co-products of the ethanol production process.

### SUMMARY OF THE PRESENT INVENTION

The present inventions described herein relate generally to processes and systems for producing grain alcohols, such as ethanol, and, more particularly, to improved methods and systems for efficiently processing, recovering, and recycling the by-products and co-products generated during the grain alcohol production process. Briefly described, aspects of the present invention include the following.

In a first aspect of the present invention, a process, operating at standard temperature and pressure, improves the quality of the fatty acids concentrated in the solid by-products and co-products created during ethanol production, while also increasing the allowable concentration of fermentable feedstock that can be handled initially at the ethanol production facility's preparation stage.

Conventionally, an ethanol production facility receives organic fermentable feedstock material, prepares the feedstock for fermentation, ferments the feedstock with yeast, distills ethanol/alcohol as its primary or desired end product, and produces stillage (also called “whole stillage”) as a by-product of the fermentation and distillation process. The facility then processes the whole stillage to produce a predominately-liquid fraction called “thin stillage” and a predominately-solids fraction called “thick stillage.” A percentage of the (untreated) thin stillage is recycled back to the feedstock preparation step without any further processing. This untreated fraction is commonly called “backset.” Backset contains, for example but not limited to, spent yeast, proteins, lactic acid, acetic acid, fatty acids, cellulose, hemicelluloses, glycerol, and sugars. The balance of the liquid fraction is sent on to an evaporation step for further processing. Evaporation is typically accomplished by applying steam heat to the liquid mixture and, under the correction combination of pressure and temperature, causes the water to boil, which then further concentrates the non-water fraction constituents, for example, but not limited to, the fatty acids, proteins, spent yeast, cellulose, hemicelluloses, and sugars present. The evaporation process produces two distinct streams, evaporation condensate and condensed solubles. Evaporation condensate is relatively free of total solids and total suspended solids but is not pure water. Rather, evaporation condensate typically contains soluble products, such as but not limited to, lactic acid, acetic acid, and glycerol, which were produced in the fermentation process or that were naturally occurring in the feedstock. Conventionally, the evaporation condensate is blended with the untreated backset and recycled back to and as part of the initial feedstock preparation stage of the ethanol production process. The thick stillage and the condensed solubles, which typically contain, for example but not limited to, proteins, fatty acids, glycerol, cellulose, hemicelluloses, and spent yeast, are then able to be sold off as wet distillers grains with solubles (WDGS) or dry distillers grains with solubles (DDGS). Before being sold off as wet distillers grains with solubles (WDGS) or dry distillers grains with solubles (DDGS), additional processing steps may be performed on the thick stillage and the condensed solubles to improve the quality (and value) of the animal feedstock and/or to extract additional water or oils. Such additional processing steps include, for example, drying, filter pressing, belt pressing, and centrifuge oil separation.

The first aspect of the present invention preferably includes a low energy separation system that performs the additional steps of: (i) adding a Generally Regarded As Safe (“GRAS”) anionic polymer to the thin or whole stillage obtained from convention ethanol production processes, (ii) controlling the amount of mixing energy applied as the GRAS polymer is mixed with the thin or whole stillage, which then results in a mixture of flocculated solids and liquid, and (iii) separating the liquid fraction from the flocculated solids fraction. The liquid, which represents a “clarified” thin stillage, can then be recycled to the feedstock preparation step as an improved “backset.” Such clarified thin stillage can then be recycled back to and combined with the process make up water, evaporation condensate, and fermentable feedstock as part of the initial feedstock preparation stage of the ethanol production process. As compared with conventional untreated backset, the clarified thin stillage has lower concentrations of, for example but not limited to, fatty acids, cellulose, hemicelluloses, glycerol, lactic acid, and acetic acid, which allows for more fermentable feedstock to be processed by the facility. The flocculated solids fraction is optionally passed on to one or more further refining steps for example, but not limited to, rotary drum drying, belt press, filter press, blending with other protein sources, or extracting fatty acids.

In a feature of the first aspect of the present invention, the capacity of the preparation stage of an ethanol production facility can be increased by up to 4.0% using the low energy separation system described herein. The capacity of the preparation stage is a function of total solids (TS) and total suspended solids (TSS) in the backset thin stillage. The capacity of the preparation stage is also a function of the viscosity of the backset thin stillage. Preferably, 90% of the minerals present in the whole stillage remain in the clarified thin stillage fraction, as soluble ions, after processing by the low energy separation system. Preferably, such minerals include, but are not limited to, calcium and magnesium. In another feature, the low energy separation system is able to reduce the amount of acids produced naturally or during fermentation in the clarified thin stillage by 10-20%. Such acids include, but are not limited to, acetic acid and lactic acid. Yet further, the low energy separation system reduces the level of glycerol produced during fermentation or occurring naturally in the clarified thin stillage by 10-30%.

In another feature, the low energy separation system is able to remove 10-60%, and preferably between 40-60%, of total solids (TS) from the thin stillage. Preferably, the total solids (TS) are defined as the soluble and insoluble constituents, such as proteins, fatty acids, crude fiber, starch, ash, carbohydrates, and amino acids, contained in the thin stillage. Preferably, 90% of the total remaining suspended solids are spent yeast.

In yet another feature, the low energy separation system is able to remove 70-99%, and preferably between 85-99%, of the total suspended solids (TSS) from the thin stillage. Preferably, the total suspended solids (TSS) are defined as insoluble constituents, such as cellulose, hemicellulose, fiber, and spent yeast, contained in the thin stillage.

In a further feature, the reduction in viscosity in the clarified thin stillage is in direct correlation to the reduction of fatty acids, wherein the total fatty acids are defined as C08:0-C24:0. Preferably, the total fatty acid reduction in the clarified thin stillage is between 75-100% and, in preferred embodiments, between 90-100%.

In another feature, the quality of the fatty acids concentrated by the low energy separation system are of better quality than fatty acids concentrated using evaporation. Preferably, the quality of the fatty acids is defined by rancidity and oxidative stability, wherein rancidity is a measure of chemical decomposition of the fatty acids and wherein oxidative stability is a measure of oil or fat's resistance to oxidation. Preferably, the total fatty acid rancidity level of the flocculated solids produced by the low energy separation system is lower than evaporation-produced condensed soluble fatty acids. Yet further, the fatty acids oxidative stability of the flocculated solids produced by the low energy separation system is higher than evaporation produced condensed fatty acids. Preferably, the total fatty acids retained in the flocculated solids produced by the low energy separation system can be isolated and recovered through, for example, but not limited to, centrifugal force, vacuum filtration, heating, and settling.

In another feature, the quantity of total fatty acids in flocculated solids concentrated by the low energy separation system exceeds that of evaporation produced condensed solubles of equal volumes of solids. Preferably, the acid value is a direct measurement of the total fatty acids present. Preferably, the total fatty acids present in the flocculated solids have 20-90%, and in preferred embodiments 50-90%, higher acid value than evaporation produced condensed solubles. Preferably, 95-100% of total fatty acids present in the thin stillage are retained in the flocculated solids.

In another feature, the GRAS anionic polymer is preferably an anionic polyacyrlamide. Preferably, the anionicity mole charge percentage has a range of between 10-100%, and in preferred embodiments, between 30-70%. Preferably, the anionicity mole charge percentage has a direct correlation to the size of the flocculated particle while the molecular weight of the anionic polymer does not have a direct correlation to the size of the flocculated particle in the stillage.

In a feature, the effective dose of GRAS anionic polymer input into the low energy separation system in this first aspect of the invention is between 5-100 ppm and, in preferred embodiments, between 20-40 ppm. Preferably, the effective dose has an inverse correlation to the anionicity mole charge percentage. Higher charges reduce the effective dose.

The pH range of the thin stillage input into the low energy separation system is between 3.0 and 9.0. Preferably, no pH adjustments using any known method are necessary or required to alter the pH of the incoming thin stillage.

In another feature, the calculated size of the cylindrical mixing chamber used by the low energy separation system, which determines the amount of rotational mixing energy, in revolutions per minute (RPM), is defined by the interdependent variables: (a) PF=process flow, measured at a rate of gallons per minute (gpm), of the thick or thin stillage input into the cylindrical mixing chamber; (b) VV=vertical velocity, measured in feet/second, of the combination of the thick or thin stillage and the polymer within the cylindrical mixing chamber; and (c) HRT—hydraulic retention time, measured in seconds, representing the amount of total time the combination of the thick or thin stillage and the polymer should take to transit through the cylindrical mixing chamber. The height of the cylindrical mixing chamber is preferably determined by the following formula: Height=VV×HRT. The diameter of the cylindrical mixing chamber is preferably determined by the following formula: Diameter=Square root ((((PF×(HRT/60))/7.48)/(Ht))/Pi.

Preferably, the HRT has a range of between 60 and 300 seconds and, in preferred embodiments, between 120 and 200 seconds. Yet further, the VV preferably has a range of 0.01 feet/second and 0.10 feet/second and, in a preferred embodiment, between 0.02 and 0.05 feet/second. Preferably, the RPM of the combined liquids-flocculated solids within the cylindrical mixing chamber is between 1 and 25 RPM and, in a preferred embodiment, between 2 and 5 RPM. Preferably, the flow of the combined liquids-flocculated solids within the cylindrical mixing chamber is laminar.

In another feature, the combination of liquids and flocculated solids output from the cylindrical mixing chamber are discharged onto a gravity filter belt. The gravity filter belt is a membrane filter that, preferably, has a membrane surface that is configured to move continuously below the discharge chute of the cylindrical mixing chamber; thereby, providing an exposed, clean surface for receiving the liquids and flocculated solids mixture.

Preferably, the numerical rating of the membrane filter defines passage of air as measured by cubic feet per minute (cfm). The effective range of air flow is typically between 70-500 cfm and, in preferred embodiments, between 100-300 cfm.

In yet a further feature, the angle of impact of the combined liquids and flocculated solids from the cylindrical mixing chamber onto the membrane filter surface is between 0 and 60 degrees. The angle of impact of the treated stillage mixture is preferably between 0 and 15 degrees and, in preferred embodiments, between 3 and 5 degrees.

In another feature, the percent reduction of the total solids (TS) is a function of the percent alcohol at which the fermentation stage finishes. Higher levels of alcohol produce more soluble total solids (TS), including lactic acid, acetic acid, and glycerol. Thus, generating more total solids (TS) that cannot be removed. Lower alcohol levels produce lower levels of soluble total solids (TS) and, thus, there is a greater reduction in total solids (TS) with this process. In one embodiment, where the alcohol generated by the fermentation step is above 13%, the preferred reduction of total solids (TS) is between 30-40%. In another embodiment, where the alcohol generated by the fermentation step is below 13%, the preferred reduction of total solids (TS) is between 50-55%.

In a second aspect of the present inventions, a process with no external heat required for concentrating for example, but not limited to, proteins, fatty acids, crude fiber, starch, acid detergent fiber, ash, carbohydrates and amino acids, in the solids fraction of the whole stillage, while separating and isolating the spent yeast in the thick or thin stillage produced from a fermentation plant is disclosed. The process increases the total percentage of amino acids and fatty acids present in the solids as well as leaving the amino acids intact and in a bio-available form.

Conventionally, an ethanol production facility receives organic fermentable feedstock material, prepares the feedstock for fermentation, ferments the feedstock with yeast, distills ethanol/alcohol as its primary or desired end product, and produces stillage (also called “whole stillage”) as a by-product of the fermentation and distillation process. The facility then processes the whole stillage to produce a predominately-liquid fraction called “thin stillage” and a predominately-solids fraction called “thick stillage.” A percentage of the (untreated) thin stillage is recycled back to the feedstock preparation step without any further processing. This untreated fraction is commonly called “backset.” Backset contains, for example but not limited to, spent yeast, proteins, lactic acid, acetic acid, fatty acids, cellulose, hemicelluloses, glycerol, and sugars. The balance of the liquid fraction is sent on to an evaporation step for further processing. Evaporation is typically accomplished by applying steam heat to the liquid mixture and, under the correction combination of pressure and temperature, causes the water to boil, which then further concentrates the non-water fraction constituents, for example, but not limited to, the fatty acids, proteins, spent yeast, cellulose, hemicelluloses, and sugars present. The evaporation process produces two distinct streams, evaporation condensate and condensed solubles. Evaporation condensate is relatively free of total solids and total suspended solids but is not pure water. Rather, evaporation condensate typically contains soluble products, such as but not limited to, lactic acid, acetic acid, and glycerol, which were produced in the fermentation process or that were naturally occurring in the feedstock. Conventionally, the evaporation condensate is blended with the untreated backset and recycled back to and as part of the initial feedstock preparation stage of the ethanol production process. The thick stillage and the condensed solubles, which typically contain, for example but not limited to, proteins, fatty acids, glycerol, cellulose, hemicelluloses, and spent yeast, are then able to be sold off as wet distillers grains with solubles (WDGS) or dry distillers grains with solubles (DDGS). Before being sold off as wet distillers grains with solubles (WDGS) or dry distillers grains with solubles (DDGS), additional processing steps may be performed on thick stillage and the condensed solubles to improve the quality (and value) of the animal feedstock and/or to extract additional water or oils. Such additional processing steps include, for example, drying, filter pressing, belt pressing, and centrifuge oil separation.

The second aspect of the present invention preferably includes a low energy separation system that performs the additional steps of: (i) adding a Generally Regarded As Safe (“GRAS”) anionic polymer to the thin or whole stillage obtained from convention ethanol production process, (ii) controlling the amount of mixing energy applied as the GRAS polymer is mixed with the thin or whole stillage, which then results in a mixture of flocculated solids and liquid, and (iii) separating the liquid fraction from the flocculated solids fraction. Next, a secondary separation process is used to separate the spent yeast from the liquid fraction. Then, the clarified liquid fraction backset (without spent yeast) is recycled to the feedstock preparation step, while the recovered spent yeast is optionally processed further using a conventional drying process or equipment, such as, but not limited to, a rotary paddle dryer, filter press, heated drying, rotary vacuum filter, or belt filter, to remove excess water. The dried spent yeast can then be sold off as animal feed. Alternatively, the recovered spent yeast does not have to be dewatered, in which case it can be sold off as a liquid yeast slurry.

Preferably, the total suspended solids (TSS) present in the clarified fraction of the stillage is greater than 90% spent yeast.

In another feature of the second aspect, the clarified fraction of thin stillage containing the spent yeast is further processed through, for example but not limited to, a solids-liquids separator, such as a disc stack centrifuge, a concentrating centrifuge, a cone bottom settling tank, or a hydrocyclone, which is used to separate the spent yeast solid fraction from the liquid fraction of the clarified thin stillage. Preferably, no external heat is used to produce the clarified thin stillage or to produce the flocculated solids. Additionally, no alteration of pH is undertaken and no additional chemicals are added.

In yet another feature, the concentration of intact and bio-available amino acids in the flocculated solids, such as the 18 essential amino acids, is higher in concentration in all 18 amino acids than evaporation produced condensed solubles. Preferably, the amino acid concentration in the flocculated solids is higher than evaporation produced condensed solubles because no additional heat is added to form the solids. Preferably, the process of forming the flocculated solids and concentrating the amino acids takes place at atmospheric pressure and temperature.

In another feature, the GRAS anionic polymer is preferably an anionic polyacyrlamide. Preferably, the anionicity mole charge percentage has a range of between 10-100%, and in preferred embodiments, between 30-70%. Preferably, the anionicity mole charge percentage has a direct correlation to the size of the flocculated particle while the molecular weight of the anionic polymer does not have a direct correlation to the size of the flocculated particle in the stillage.

In a feature, the effective dose of GRAS anionic polymer input into the low energy separation system in this second aspect of the invention is between 5-100 ppm and, in preferred embodiments, between 20-40 ppm. Preferably, the effective dose has an inverse correlation to the anionicity mole charge percentage. Higher charges reduce the effective dose.

Preferably, the numerical rating of the membrane filter used to dewater the flocculated solids and separate out the clarified thin stillage defines passage of air as measured by cubic feet per minute (cfm). The effective range of air flow is typically between 70-500 cfm and, in preferred embodiments, between 100-300 cfm.

The present inventions also encompasses computer-readable medium having computer-executable instructions for performing methods of the present invention, and computer networks and other systems that implement the methods of the present invention.

The above features as well as additional features and aspects of the present invention are disclosed herein and will become apparent from the following description of preferred embodiments of the present invention.

### BRIEF DESCRIPTION OF THE DRAWINGS

Further features and benefits of the present inventions will be apparent from a detailed description of preferred embodiments thereof taken in conjunction with the following drawings, wherein similar elements are referred to with similar reference numbers, and wherein:

FIG. 1 is a high level flowchart illustrating the steps, outputs, and recycling processes of a conventional (prior art) ethanol production process;

FIG. 2 is a high level flowchart illustrating the steps, outputs, and recycling processes of an improved ethanol production process of an embodiment of the present invention;

FIG. 3 is a perspective view of a low energy separation system, including a cylindrical mixing chamber and a gravity filter belt, used by the improved ethanol production process of FIG. 2;

FIG. 4 is a table illustrating the reduction of solids achievable by the low energy separation system of FIG. 3 compared to the angle of impact of flocculated solids exiting the cylindrical mixing chamber and landing on the gravity filter belt;

FIG. 5 is a table illustrating the reduction of solids achievable by the low energy separation system of FIG. 3 based on the level of solids in the thin stillage input into the low energy separation system;

FIG. 6 is a first table illustrating the improved recovery of amino acids achievable by the low energy separation system of FIG. 3;

FIGS. 7a and 7b is a table illustrating the improved recovery of fatty acids achievable by the low energy separation system of FIG. 3;

FIG. 8 is a second table illustrating the improved recovery of amino acids achievable by the low energy separation system of FIG. 3;

FIG. 9 is a table illustrating actual test results showing the differences between conventional, untreated thin stillage and the clarified thin stillage output by the low energy separation system of FIG. 3;

FIG. 10 is a table illustrating actual test results showing the differences between conventional, evaporation-produced condensed solubles and the flocculated solids output by the low energy separation system of FIG. 3; and

FIG. 11 is a high level flowchart illustrating the steps, outputs, and recycling processes of an improved ethanol production process of another embodiment of the present invention.

### DETAILED DESCRIPTION OF PREFERRED EMBODIMENTS

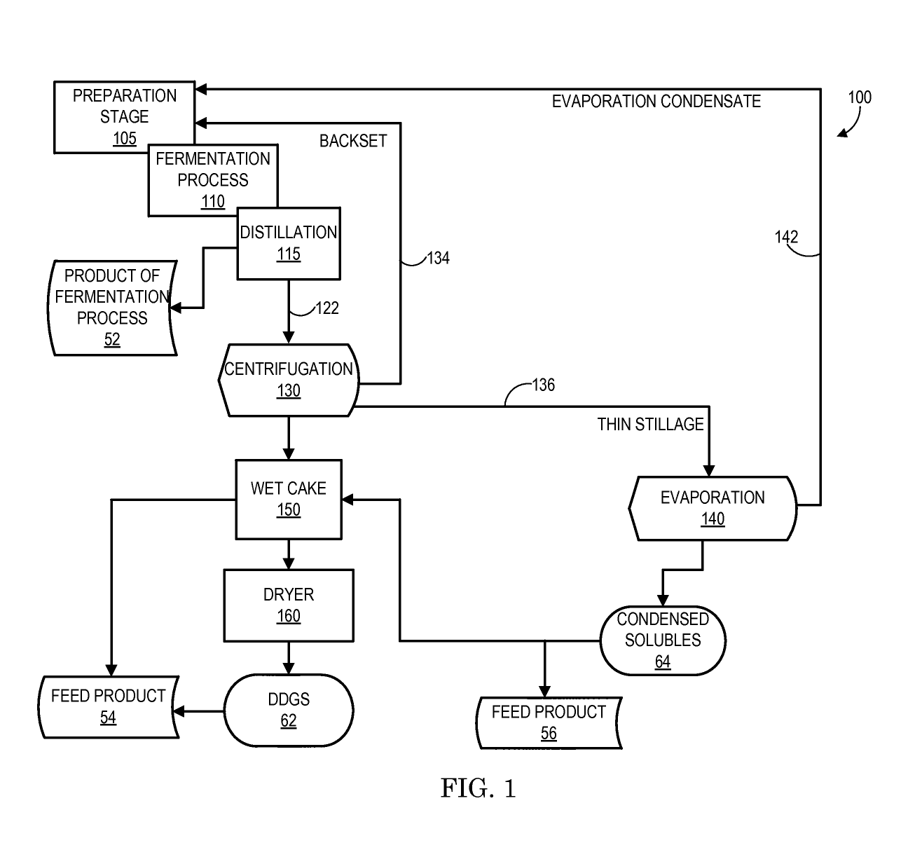

FIG. 1 illustrates the conventional, high level process 100 used by ethanol production facilities to generate ethanol as a primary or desired end product and for handling the whole stillage by-product that results from such ethanol production. The primary stages of ethanol production include a preparation stage 105, a fermentation process 110, and a distillation stage 115.

As part of the preparation stage 105, the ethanol production facility receives organic fermentable feedstock material, such or corn or other grain feedstock, and prepares the feedstock for fermentation. Part of the preparation includes dry milling or wet milling the corn or other grain feedstock. With dry milling, the corn or other grain feedstock is ground up into a dry mixture of particles using a hammer or roller mill. The dry mixture of particles or milled grains is then combined with water and enzymes to break up the starch from the corn/grain into smaller fragments to yield a liquefied mash.

The liquefied mash is then subjected to a fermentation process 110, in which the starch in the liquefied mash is converted to sugars using a saccharification process. The sugars are then fermented with yeast to facilitate their conversion to ethanol.

At the distillation stage 115, ethanol 52 is produced as the primary or desired end product of the ethanol production facility. Ethanol yield is dependent upon the initial starch content of the corn/grain as well as the availability of the starch to the enzymes that are used in the saccharification phase of the fermentation process 110. In conventional processes, the availability of starch is governed, in part, by the success of the dry milling or similar step in which the corn/grain is broken up into smaller particles. Production processes currently used in commercial ethanol plants are not able to achieve maximum theoretical ethanol yield; thus, more corn/grain than theoretically needed must be used to produce a certain amount of ethanol.

In addition to the ethanol 52, whole stillage 122 is produced as a by-product of the fermentation and distillation processes 110, 115. The whole stillage 122 by-product is then sent to a solid-liquid separator 130, such as a centrifuge or decanter centrifuge, which produces two output streams, a heavy stream and a light stream. The heavy stream is a predominately-solids fraction called “thick stillage” 132 and the light stream is a predominately-liquid fraction called centrate or “thin stillage” 134, 136.

The thick stillage 132 is output as a wet cake (or wet distillers grains with solubles (WDGS)) 150 that contains, predominantly, proteins, fatty acids, glycerol, cellulose, hemicelluloses, spent yeast, and some water. The wet cake (or wet distillers grains with solubles (WDGS)) 150 can then be sold off, as is and without further processing, as an animal feed product 54. Alternatively, the wet cake (or wet distillers grains with solubles (WDGS)) 150 can be sent to a dryer 160, which is used to remove additional water. The resulting product output from the dryer is dry distillers grains with solubles (DDGS) 62, which can also be sold off as an animal feed product 54.

A percentage of the (untreated) thin stillage 134 output from the solid-liquid separator 130 is recycled back to the feedstock preparation stage 105 without any further processing. This untreated fraction is commonly called “backset.” Backset contains, for example but not limited to, spent yeast, proteins, lactic acid, acetic acid, fatty acids, cellulose, hemicelluloses, glycerol, sugars, and water. The balance of the thin stillage 136 is sent on to an evaporator or evaporation process 140. Evaporation is typically accomplished by applying heat, such as steam heat, to the liquid mixture 136 and, under the correction combination of pressure and temperature, causes the water to boil, which then further concentrates the non-water fraction constituents, for example, but not limited to, the fatty acids, proteins, spent yeast, cellulose, hemicelluloses, and sugars present. Typically, the non-water fraction constituents in the thin stillage 134 provided as backset as well as the thin stillage 136 provided to the evaporator 140 has 2-3% total suspended solids (TSS) and 5-9% total solids (TS).

The evaporation process 140 produces two distinct output streams, evaporation condensate 142 and condensed solubles 64. Evaporation condensate 142 is relatively free of total solids (TS) and total suspended solids (TSS), is clear in appearance, but is not pure water. Rather, the evaporation condensate 142 typically contains soluble products, such as but not limited to, lactic acid, acetic acid, and glycerol, which were produced in the fermentation process or that were naturally occurring in the corn/grain feedstock. Conventionally, the evaporation condensate is blended with the untreated backset 134 and recycled back to and as part of the initial feedstock preparation stage 105 of the ethanol production process.

Like the wet cake 150, the condensed solubles 64 typically contain proteins, fatty acids, glycerol, cellulose, hemicelluloses, and spent yeast. The condensed solubles 64 are also known as “syrup.” The “syrup” concentration of solids varies depending on the operating characteristics of the ethanol production facility. However, typical solids concentration in the “syrup” range from 25-35%. Although not shown in FIG. 1, partially concentrated “syrup” 64 is typically sent through a mechanical separation process, such as a centrifuge, which is used to recover and extract oil or bio-oil. The remaining solids in the syrup are further concentrated and become the finished “syrup.” The finished “syrup” can be sold, as is, as an animal feed product 56 or, alternatively, it can be combined with the wet cake 150 and then sold off as part of the wet distillers grains with solubles (WDGS)) 150 or, after drying, sold off as part of the dry distillers grains with solubles (DDGS).

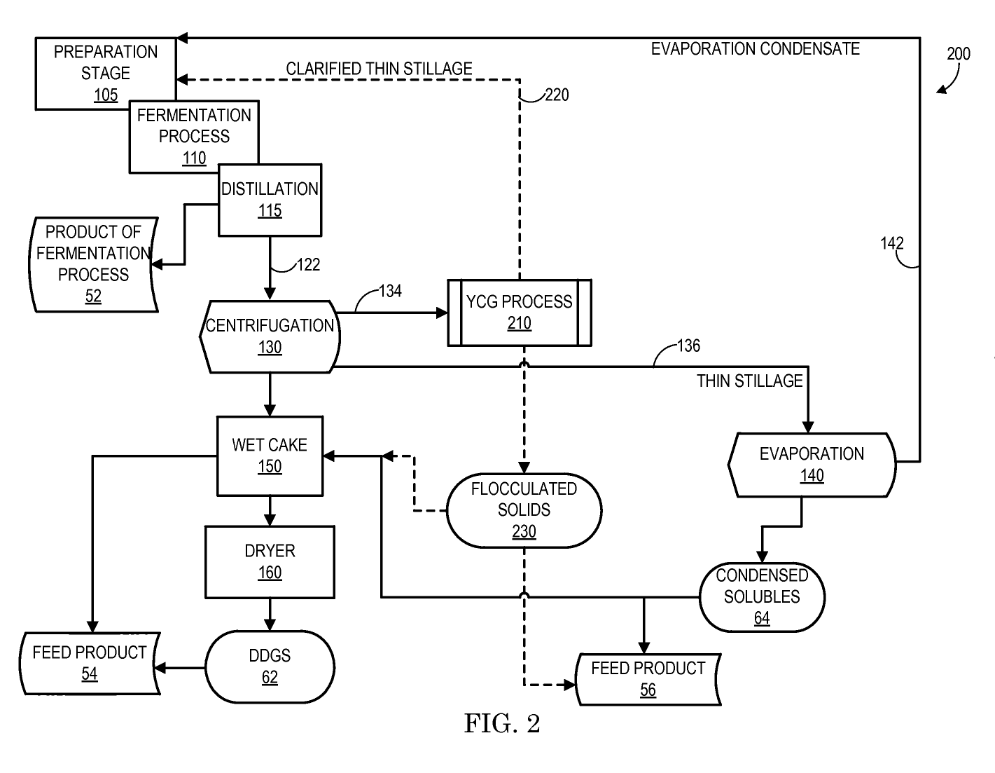

Turning now to FIG. 2, an improved high level process 200 for handling the whole stillage by-product that results from ethanol production in accordance with aspects of the present invention is disclosed. The improved high level process 200 is similar to the conventional high level process 100 of FIG. 1, with the following exceptions.

Specifically, the fraction of untreated thin stillage 134 output from the solid-liquid separator 130 that would conventionally be recycled back to the feedstock preparation stage 105 as backset is instead sent to a low energy separation system 210. With conventional ethanol processes, the backset that is sent directly back to the feedstock preparation stage 105 has 2-3% total suspended solids (TSS) and 5-9% total solids (TS) still present in it. These solids are those that cannot be removed effectively by the solid-liquid separator 130. They are non fermentable. It will be appreciated by those of skill in the art that high levels of total suspended solids (TSS) and total solids (TS) in the backset reduce the capacity for the ethanol process to take in fresh corn/grain feedstock since the backset is not free of solids, but is instead fouled with non fermentable materials. However, the cost of operating the ethanol processing facility without using the backset is higher than not doing so, which is why backset is typically recycled.

The low energy separation system 210 illustrated in FIG. 2 provides a means for removing the non-fermented total suspended solids (TSS) and total solids (TS) from the backset thin stillage 134 without the use of heat. Effectively, the low energy separation system 210 performs a similar function on the backset thin stillage 134, as the evaporator or evaporation process 140 traditionally does with the other stream of thin stillage 136. As will be described in greater detail hereinafter, the low energy separation system 210 produces two output streams, a liquid fraction called clarified thin stillage 220 and a solids fraction called flocculated solids 230. The clarified thin stillage 220 replaces the conventional backset thin stillage 134 that is typically recycled back to the feedstock preparation stage 105.

The clarified thin stillage 220 is similar to untreated thin stillage 134, but has 10-60% (and preferably 40-60%) of the total solids (TS) and 70-99 (and preferably 85-99%) of the total suspended solids (TSS) removed. The clarified thin stillage 220 output from the low energy separation system 210 retains most of the spent yeast contained in the untreated thin stillage 134. The spent yeast serves a value in the preparation stage 105 of the ethanol process, since the spent yeast acts as a source of nutrition for the active yeast in the fermentation process 110. Advantageously, the viscosity of the clarified thin stillage 220 is lower than the untreated thin stillage 134 due to the removal of the free fatty acids (from the liquid stream) by the low energy separation system 210.

The flocculated solids 230 are different from the evaporation-produced syrup or condensed solubles 64 in that the flocculated solids are higher in amino acid concentrations and free fatty acid concentrations on equivalent basis. In addition, the flocculated solids 230 contain all the bio-oil that is present in the untreated thin stillage 134. In other words, the bio-oils from the untreated thin stillage 134 are not included in the clarified thin stillage 220. Advantageously, the oil concentrated in the flocculated solids 230 by the low energy separation system 210 has a similar concentration to the oils concentrated in the evaporation-produced syrup or condensed solubles 64, but the oil in the flocculated solids 230 is not damaged in the same manner as the oil is damaged through the heat of the evaporation process 140. Testing in lab centrifuges shows that oil contained in the flocculated solids 230 can be released and extracted using conventional centrifuge separation techniques. Similar to the finished “syrup” 64 from FIG. 1, the flocculated solids 230 can be sold, as is, as an animal feed product 56 or, alternatively, it can be combined with the wet cake 150 and then sold off as part of the wet cake (or wet distillers grains with solubles (WDGS)) 150 or, after drying, sold off as part of the dry distillers grains with solubles (DDGS).

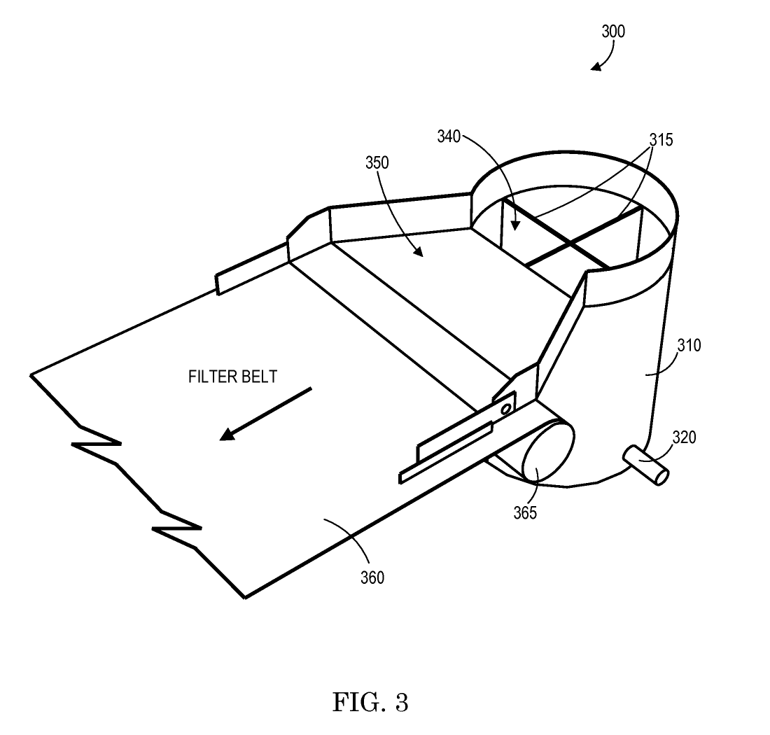

Turning now to FIG. 3, various components of the low energy separation system 210 of FIG. 2 are described in greater detail. FIG. 3 illustrates a perspective view of static mixer 300 associated with the low energy separation system 210. The static mixer 300 includes a generally-cylindrical mixing chamber 310 that includes a plurality of baffles 315 that dissipate the mixing energy within the mixing chamber 310. An inlet 320 located near the bottom of the cylindrical mixing chamber 310 receives the incoming thin stillage stream 134 (as shown in FIG. 2). The pH range of the thin stillage 134 input into the low energy separation system 210 is between 3.0 and 9.0. Preferably, no pH adjustments using any known method are necessary or required to alter the pH of the incoming thin stillage 134.

A pre-selected, high molecular weight, high mole charge, anionic GRAS-designation polymer, described in greater detail hereinafter, is injected into a preliminary, static mixer (not shown) for mixing with the thin stillage 134 before the mixture of “treated material” is introduced into the cylindrical mixing chamber 310 through the inlet 320.

The preliminary, static mixer is in-line with the inlet 320 and is located a distance of approximately four (4) times the diameter of the pipe that feeds into the inlet 320. For example, if the diameter of the pipe feeding into the inlet 320 is 4 inches, then the output from the preliminary, static mixer would be placed approximately sixteen (16) inches, using straight piping, from the inlet 320 of the cylindrical mixing chamber 310.

The results of mixing the treated material (i.e., the combination of thin stillage and the GRAS anionic polymer) within the cylindrical mixing chamber 310 results in an output of flocculated solids 230 and clarified thin stillage 220, as previously described with reference to FIG. 2. The combination of flocculated solids 230 and clarified thin stillage 220 are discharged or output through the top 340 of the cylindrical mixing chamber 310 onto a low angle discharge chute 350, which directs the combination of the flocculated solids 230 and clarified thin stillage 220 onto a filter belt 360, which is driven by a roller 365.

In practice, the thin stillage and the pre-selected, high molecular weight, high mole charge, anionic GRAS-designation polymer combined in the preliminary, static mixer is then fed into the cylindrical mixing chamber 310 through the inlet 320. The static mixer 300 delivers a specific amount of mixing such that the vertical velocity of the treated material (i.e., the combination of the thin stillage and the polymer) preferably does not exceed 0.05 feet/second. From testing, it has been determined that a vertical velocity above 0.05 ft/sec results in too much mixing energy, which reduces the amount of flocculation and desired, solid particle formation. As vertical velocity decreases, particle size increases. Through testing, it has been determined that optimum particle size appeared to be produced in preferred embodiments of the invention at a vertical velocity of approximately 0.016 ft/sec. From testing, it has been determined that, at a vertical velocity below 0.01 ft/sec, particle formation degrades and solids settle out in the bottom of the cylindrical mixing chamber 310 rather than being carried up and out onto the low angle discharge chute 350 and then onto the filter belt 360.

In a preferred embodiment, the dimensions of the cylindrical mixing chamber 310 are determined by inputting three (3) preselected values: (a) PF=process flow, measured at a rate of gallons per minute (gpm), of thick or thin stillage input into the static mixer 300; (b) VV=vertical velocity, measured in feet/second, of the combination of the thick or thin stillage and the polymer and, preferably, within the range of 0.01-0.05 feet/second; and (c) HRT—hydraulic retention time, measured in seconds, representing the amount of total time the combination of the thick or thin stillage and the polymer should take to transit through the cylindrical mixing chamber 310.

The height of the cylindrical mixing chamber 310 is preferably determined by the following formula:

Height=VV×HRT

The diameter of the cylindrical mixing chamber 310 is preferably determined by the following formula:

Diameter=Square root((((PF×(HRT/60))/7.48)/(Ht))/Pi

Preferably, the mixing chamber 310 is cylindrical in shape to enhance the flocculation formation. The cylindrical shape eliminates sharp corners and abrupt changes in fluid direction, which would otherwise increase turbulence and hinder flocculation formation. Internally, the plurality of baffles 315 dissipate the energy of motion, as the polymer-treated thick or thin stillage is mixed within the cylindrical mixing chamber 310. The combination of proper sizing and correct baffle location improves flocculation formation. Preferably, the flow of the combined liquids-flocculated solids within the cylindrical mixing chamber is laminar. The location of the baffles 315 enables approximately 15-30 seconds of mixing within the lower portion of the cylindrical mixing chamber 310 based on maximum process flow (PF) that the cylindrical mixing chamber 310 is designed to handle. Testing has shown that, if the treated material (i.e., the GRAS-polymer-treated stillage) is allowed to mix beyond 30 seconds, the flocculated solids formation starts to degrade and solids are not formed. If the mixing time of the treated material is less than 15 seconds, higher dosages of the GRAS polymer are required to overcome incomplete mixing.

Preferably, the HRT has a range of between 60 and 300 seconds and, in preferred embodiments, between 120 and 200 seconds. Yet further, the VV preferably has a range of 0.01 feet/second and 0.10 feet/second and, in a preferred embodiment, between 0.02 and 0.05 feet/second. Preferably, the RPM of the combined liquids-flocculated solids within the cylindrical mixing chamber is between 1 and 25 RPM and, in a preferred embodiment, between 2 and 5 RPM.

Based on the preferred dimensions of the cylindrical mixing chamber 310, the pre-selected anionic polymer is added as a liquid to the preliminary, static mixer. Feed rates for the pre-selected GRAS anionic polymer are preferably between 5-100 parts per million (ppm) (and in preferred embodiments, 20-40 ppm), depending on the total suspended solids (TSS) loading in the thin stillage. The GRAS anionic polymer is preferably an anionic polyacyrlamide. Preferably, the anionicity mole charge percentage has a range of between 10-100%, and in preferred embodiments, between 30-70%. Preferably, the anionicity mole charge percentage has a direct correlation to the size of the flocculated particle while the molecular weight of the anionic polymer does not have a direct correlation to the size of the flocculated particle in the stillage.

The chemical reaction between the polymer and the thick or thin stillage starts nearly instantaneously when the polymer is combined with the thick or thin stillage within the preliminary, static mixer and continues as the treated material is fed into the static mixing chamber 310. Once the polymer is added and completely mixed into the stillage within the static mixing chamber 310, the energy of mixing must be removed expeditiously in order for flocculated particles to form. Once the flocculation has formed, any additional mixing energy will tend to destabilize the flocculated particles and inhibit further flocculation. Higher total suspended solids (TSS) increase the demand for anionic polymer. It is not critical to make the flocculated solids float or sink, as all the treated material will flow up and out the top 340 of the cylindrical mixing chamber 310 and discharge onto the gravity belt 360 for dewatering and separation of the flocculated solids 230 and clarified thin stillage 220.

The combination of flocculated solids 230 and clarified thin stillage 220 exit the top 340 of the static mixing chamber 310 and are deposited across the entire width of the gravity filter belt 360. Preferably, the combination of flocculated solids 230 and clarified thin stillage 220 are deposited onto the gravity filter belt 360 at an angle between 3-12% as referenced from the surface of the gravity filter belt 360 to the outlet of the discharge chute 350. As the angle increases between the outlet of the discharge chute 350 and the surface of the gravity filter belt 360, the percentage of solids passing through the gravity filter belt 360 (and contaminating the clarified thin stillage 220) increases. At an angle above 12%, the energy of impact tends to break apart the flocculated solids 230 before dewatering can take place, which increases the percentage of solids passing through the gravity filter belt 360 and, correspondingly, increases the level of solids that contaminate the clarified thin stillage 220. The net result is a very low solids recovery rate.

The gravity filter belt 360 has a membrane surface that, preferably, is configured to move continuously below the discharge chute 350 of the cylindrical mixing chamber 310; thereby, providing an exposed, clean filter surface for receiving the discharge of the liquids and flocculated solids mixture. Preferably, the numerical rating of the membrane surface defines passage of air as measured by cubic feet per minute (cfm). The effective range of air flow through the membrane surface is typically between 70-500 cfm and, in preferred embodiments between 100-300 cfm.

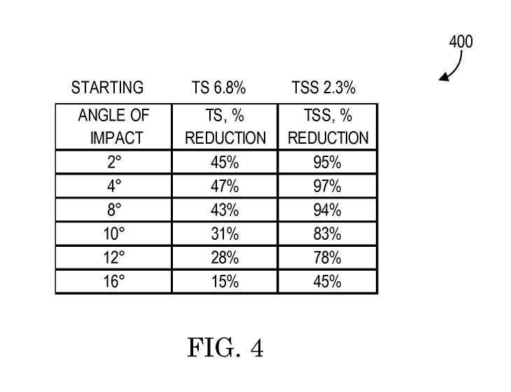

The data shown on table 400 of FIG. 4 illustrates the cumulative average total suspended solids (TSS) and total solids (TS) from multiple sets of tests on impact angle and the resulting reduction obtained therefrom. The data from table 400 shows that as the angle of impact of the flocculated solids leaving the discharge chute 350 increases, the rate of solids capture decreases. The slight improvement obtained at an angle of impact of 4 degrees, as compared to 2 degrees, can be accounted for by the rate at which the solids spread out over the gravity filter belt 360 and shear some of the water away from the flocculated solids but without damaging the flocculated solids. It was determined, through testing, that an angle of impact below 2 degrees caused the flocculated solids being discharged from the discharge chute 350 to collect or bunch together at the intersection of the discharge chute 350 and the gravity filter belt 360, which slightly hindered the dewatering and capture process obtainable at angles of impact greater than 2 degrees.

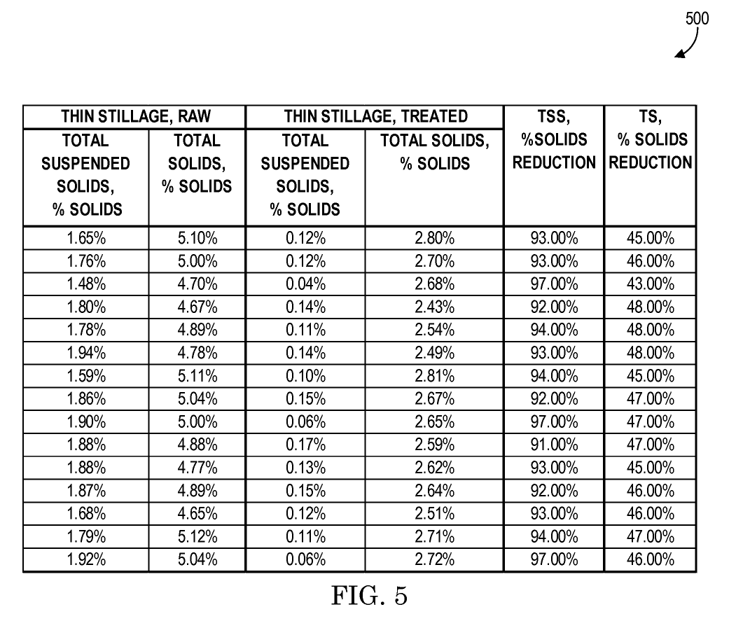

The data shown on table 500 of FIG. 5 illustrates the reduction of total suspended solids (TSS) and total solids (TS) that can be obtained by the low energy separation system 210 by comparing the solids in the untreated, backset thin stillage 134 that is input into the low energy separation system 210 with the solids remaining in the clarified thin stillage output by the low energy separation system 210. Specifically, the data shown in table 500 was obtained using an angle of impact of 4 degrees for the flocculated solids leaving the discharge chute 350. Through multiple laboratory and actual on-site analysis, it has been determined that the sequence of chemical/mechanical processes is a dose responsive process. A dose of 15-40 milligrams per liter (mg/L) is preferred. In practice, the reduction of total solids (TS) that can be obtained by the low energy separation system 210 is, on average, 30-50% removal.

Through testing, it has been determined that the solids that can be removed from the untreated thin stillage 134 (and output as clarified thin stillage 220) by the low energy separation system 210 can be classified into three (3) primary categories, by percentage: (a) non-fermentable solids: 30-35%; (b) vegetable oils: 3-5%; and (c) spent yeast: less than 1%.

The rate of solids removal achievable by the low energy separation system 210 will necessarily vary based on how efficiently the ethanol production facility is able to separate solids out of the whole stillage in the solid-liquid separator 130 and the dose response curve of the anionic polymer. It has been determined that the concentration of alcohol in the fermentation process 110 will impact the capability of the low energy separation system 210 to reduce total solids (TS). Typically, higher alcohol levels will result in lower total solids (TS) reductions.

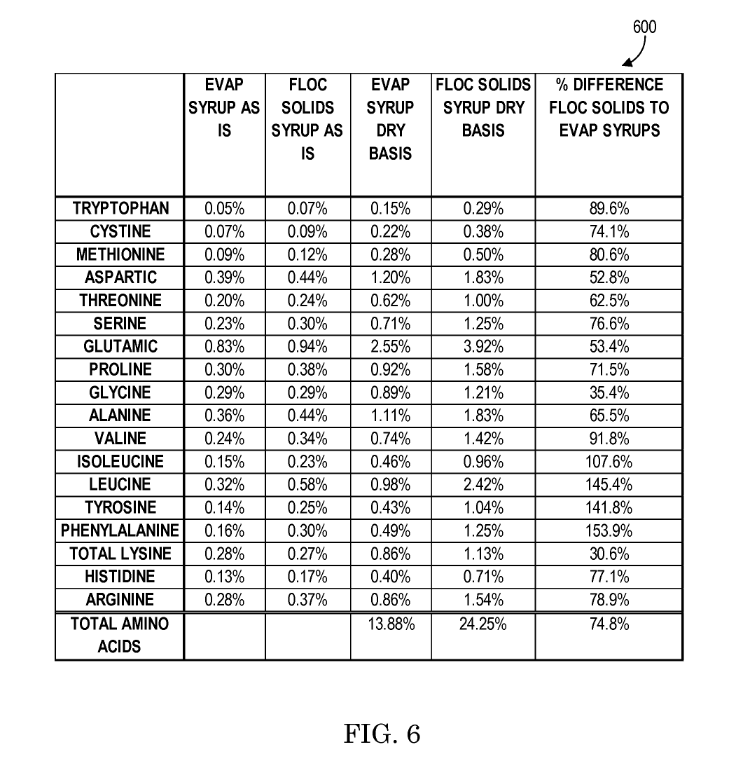

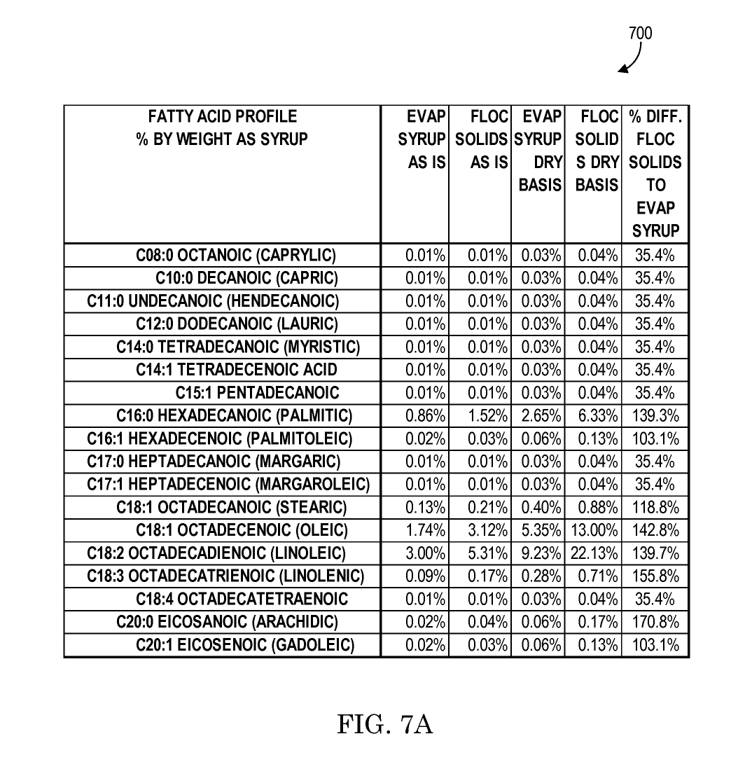

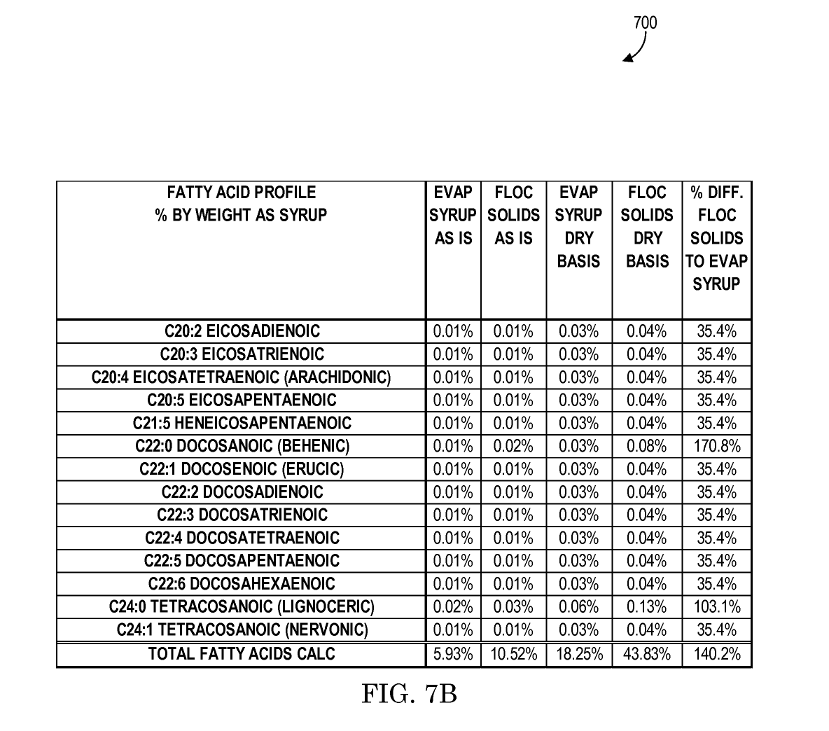

Testing of the flocculated solids output by the low energy separation system 210 has shown that the nutritional value of the flocculated solids 230 is significantly higher than traditional evaporation derived thin stillage syrup or more commonly called condensed solubles 64. The differences in nutritional value can be shown via the percentages of total amino acids and total free fatty acids present in the flocculated solids 230 as compared to the traditional condensed soluble syrup 64. These results are illustrated in table 600 of FIG. 6 and table 700 of FIGS. 7a and 7b. In addition, the differences in nutritional value (amino acids) between the flocculated solids 230 output by the low energy separation system 210 as compared to the DDGS 62 output by conventional ethanol production processes is illustrated in table 800 of FIG. 8

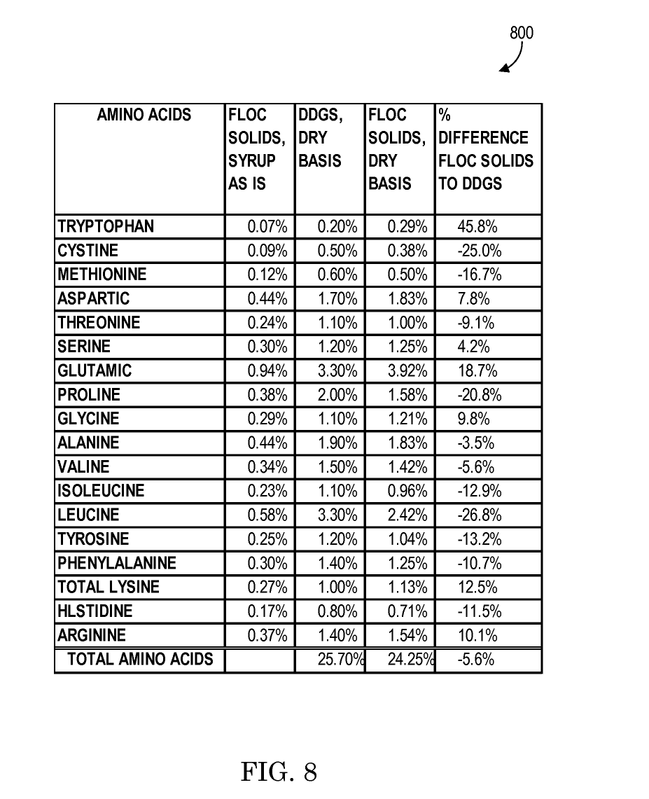

Turning now to FIG. 9, table 900 illustrates actual testing results that show the differences between untreated thin stillage 134 that is traditionally used as backset and the clarified thin stillage 220 output by the low energy separation system 210 of the present invention. DP4 and DP3 are complex sugar strands that are monitored as they break down to glucose.

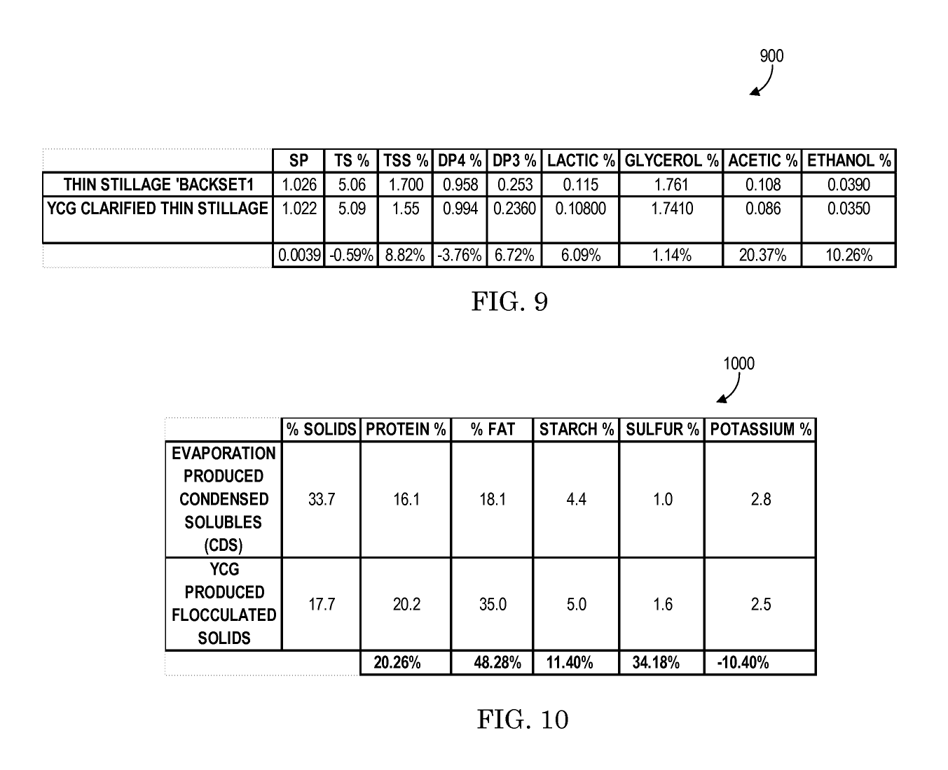

Table 1000 of FIG. 10 illustrates actual testing results that show the differences between the evaporation-produced condensed solubles 64 and the flocculated solids 230 produced by the low energy separation system 210. As shown in this particular test, the flocculated solids were lower in total solids (TS) due to the previous method of dewatering; yet the results, which are the net effect of the polymer forming the flocculated solids and retaining the total solids (TS) and total suspended solids (TSS), are still positive. The reduction of starch is positive—the processes performed by the low energy separation system 210 selectively allowing starch to return to the preparation stage 105. This is starch that did not get converted in the initial fermentation process 110. Higher sulfur removal rates indicate the reduction of sulfur that is returned to the preparation stage 105. Lower potassium indicates that this vital mineral remains with the clarified thin stillage that is sent back to the preparation stage 105.

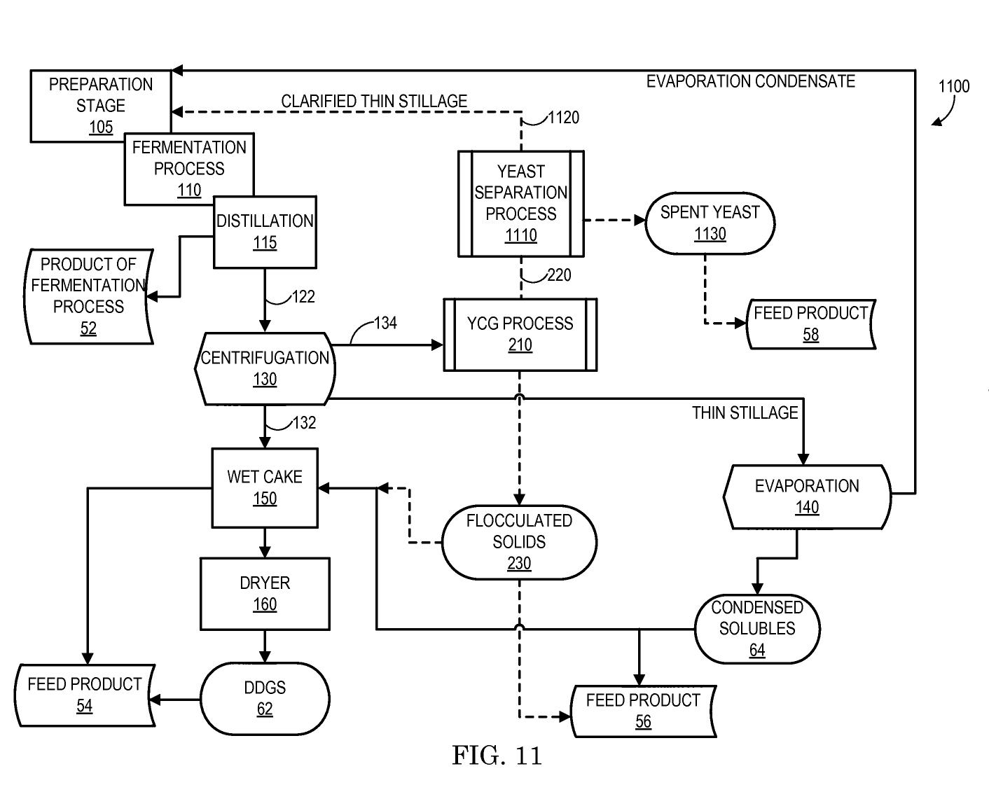

Turning now to FIG. 11, another improved high level process 1100 for handling the thin stillage 134 portion of the whole stillage 122 by-product that results from ethanol production in accordance with aspects of the present invention is disclosed. The improved high level process 1100 is similar to the improved high level process 200 of FIG. 2, with the following exceptions.

Specifically, before the clarified thin stillage 220 output from the low energy separation system 210 is recycled back to the feedstock preparation stage 105 as is, it is possible and, for some business applications, may be more desirable to extract available spent yeast 1130 from the clarified thin stillage 220 for use as feed product 58, rather than keeping the spent yeast in the clarified thin stillage for use as a source of nutrition for the active yeast in the fermentation process 110.

The process 1110 for extracting the spent yeast 1130 from the clarified thin stillage 220 is accomplished as follows. The spent yeast 1130 has a specific gravity of about 1.2. If the clarified thin stillage 220 is allowed to sit undisturbed for approximately 15 minutes in a holding container, the majority of the spent yeast 1130 will settle to the bottom of the holding container. Testing has shown that simple centrifugal energy can also be used to separate out or extract the spent yeast 1130 from the resulting, improved clarified thin stillage 1120. The improved clarified thin stillage 1120 provided as “improved” backset to the preparation stage 105, is similar to the clarified thin stillage 220 output by the low energy separation system 210, having lower total solids (TS) and total suspended solids (TSS) than the conventional thin stillage 134, but without all or a substantial portion of spent yeast. The spent yeast 1130 can be sold off as feed product 58 in liquid yeast slurry form or, optionally, the spent yeast can be subjected to a dewatering process, using conventional dryer equipment or processes, such as a rotary paddle dryer, filter press, heated drying, rotary vacuum filter, or belt filter. The dried spent yeast can then be sold off as animal feed product 58.

In view of the foregoing detailed description of preferred embodiments of the present invention, it readily will be understood by those persons skilled in the art that the present invention is susceptible to broad utility and application. While various aspects have been described in the context of screen shots, additional aspects, features, and methodologies of the present invention will be readily discernable therefrom. Many embodiments and adaptations of the present invention other than those herein described, as well as many variations, modifications, and equivalent arrangements and methodologies, will be apparent from or reasonably suggested by the present invention and the foregoing description thereof, without departing from the substance or scope of the present invention. Furthermore, any sequence(s) and/or temporal order of steps of various processes described and claimed herein are those considered to be the best mode contemplated for carrying out the present invention. It should also be understood that, although steps of various processes may be shown and described as being in a preferred sequence or temporal order, the steps of any such processes are not limited to being carried out in any particular sequence or order, absent a specific indication of such to achieve a particular intended result. In most cases, the steps of such processes may be carried out in various different sequences and orders, while still falling within the scope of the present inventions. In addition, some steps may be carried out simultaneously. Accordingly, while the present invention has been described herein in detail in relation to preferred embodiments, it is to be understood that this disclosure is only illustrative and exemplary of the present invention and is made merely for purposes of providing a full and enabling disclosure of the invention. The foregoing disclosure is not intended nor is to be construed to limit the present invention or otherwise to exclude any such other embodiments, adaptations, variations, modifications and equivalent arrangements, the present invention being limited only by the claims appended hereto and the equivalents thereof.

I claim:

1. A system for improving quality of solids and liquids recovered at atmospheric pressure and temperature from a stillage stream generated as a by-product of an ethanol production process, the recovered solids having higher bio-available amino acids and fatty acids than evaporation-produced condensed solubles obtainable from the stillage stream, the recovered liquids having less total solids (TS) and total suspended solids (TSS) than centrifuge-produced thin stillage obtainable from the stillage stream, the system comprising:
a static mixer having:
(i) an input for receiving the stillage stream and for receiving a predetermined amount of generally-regarded-as-safe (GRAS) anionic polymer, the combined stillage stream and GRAS anionic polymer forming a GRAS-treated stillage;
(ii) a cylindrical mixing chamber configured to mix the GRAS-treated stillage at a predetermined laminar flow rate that chemically generates wet flocculated solids and liquid co-product; and
(iii) a discharge chute for outputting the wet flocculated solids and liquid co-products from the cylindrical mixing chamber;
and a moving, gravity filter belt being sloped at an angle relative to the discharge chute, one end of the filter belt positioned to receive the wet flocculated solids and liquid co-products output from the discharge chute of the cylindrical mixing chamber, the filter belt having a membrane surface configured to allow liquid co-products and liquids settling out from the wet flocculated solids to pass therethrough as clarified, thin stillage, the membrane surface further configured to retain and discharge dry flocculated solids at the other end of the filter belt;
wherein the clarified, thin stillage represents the recovered liquids and the dry flocculated solids represent the recovered solids.

2. The system of claim 1, wherein the stillage stream is thick or thin stillage.

3. The system of claim 1, wherein 10-60% of the total solids (TS) and 70-99% of the total suspended solids (TSS) in the stillage stream are captured in the dry flocculated solids.

4. The system of claim 1, wherein the GRAS anionic polymer is an anionic polyacrylamide having an anionicity mole charge percentage between 30-70%.

5. The system of claim 1, wherein the predetermined amount of GRAS anionic polymer is between 20-40 ppm.

6. The system of claim 1, wherein the cylindrical mixing chamber has a rotational mixing energy measured in revolutions per minute (RPM) that is a function of its height and its diameter, wherein the height (Ht) is equal to VV×HRT, wherein VV represents vertical velocity of the GRAS-treated stillage through the cylindrical mixing chamber and HRT represents hydraulic retention time of the GRAS-treated stillage within the cylindrical mixing chamber, and wherein the diameter is equal to square root ((((PF×(HRT/60))/7.48)/(Ht))/Pi, wherein PF represents process flow in gallons per minute of the GRAS-treated stillage within the cylindrical mixing chamber.

7. The system of claim 6, wherein the HRT is measured in seconds and has a range of between 60 and 300 seconds, wherein the VV is measured in feet/second and has a range of between 0.01 and 0.10 feet/second, and wherein the RPM of the GRAS-treated stillage within the cylindrical mixing chamber is between 2 and 5 RPM.

8. The system of claim 7, wherein the VV has a preferred range between 0.016 and 0.050 feet/second.

9. The system of claim 7, wherein the cylindrical mixing chamber includes baffles to control the RPM of the GRAS-treated stillage within the cylindrical mixing chamber.

10. The system of claim 1, wherein the membrane surface of the gravity filter belt has an air flow rating between 100-300 cubic feet per minute (cfm).

11. The system of claim 1, wherein the angle of the slope of the gravity filter belt relative to the discharge chute is between 0 and 15 degrees.

12. The system of claim 1, wherein the clarified, thin stillage is recycled back to a preparation stage of the ethanol production process.

13. The system of claim 1, wherein the clarified, thin stillage is then provided to an evaporator for further separation of solids and liquids contained in the clarified, thin stillage.

14. The system of claim 1, wherein the dry flocculated solids are collected and sold off either as wet distillers grains with solubles (WDGS) or dry distillers grains with solubles (DDGS).

15. The system of claim 1, wherein oil is extracted from the dry flocculated solids.

16. The system of claim 1, wherein the clarified, thin stillage includes spent yeast and wherein the spent yeast is extracted from the clarified, thin stillage using a solids-liquids separator.

17. The system of claim 16, wherein the solids-liquids separator is a disc stack centrifuge, a concentrating centrifuge, a cone bottom settling tank, or a hydrocyclone.

18. A method for improving quality of solids and liquids recovered at atmospheric pressure and temperature from a stillage stream generated as a by-product of an ethanol production process, the recovered solids having higher bio-available amino acids and fatty acids than evaporation-produced condensed solubles obtainable from the stillage stream, the recovered liquids having less total solids (TS) and total suspended solids (TSS) than centrifuge-produced thin stillage obtainable from the stillage stream, comprising the steps of:
combining (i) the stillage stream obtained from the ethanol production process with (ii) a predetermined amount of generally-regarded-as-safe (GRAS) anionic polymer in a static mixer, the static mixer having a cylindrical mixing chamber, the combined stillage stream and GRAS anionic polymer forming a GRAS-treated stillage;
mixing the GRAS-treated stillage at a predetermined laminar flow rate within the cylindrical mixing chamber of the static mixer, wherein mixing the GRAS-treated stillage chemically generates wet flocculated solids and liquid co-product;
discharging the wet flocculated solids and liquid co-product from the static mixer; and
filtering the discharged wet flocculated solids and liquid co-product to generate a clarified, thin stillage and dry flocculated solids;
wherein the clarified, thin stillage represents the recovered liquids and the dry flocculated solids represent the recovered solids, wherein 10-60% of the total solids (TS) and 70-99% of the total suspended solids (TSS) in the stillage stream are captured in the dry flocculated solids.

19. The method of claim 18, wherein the stillage stream is thick or thin stillage.

20. The method of claim 18, wherein the GRAS anionic polymer is an anionic polyacrylamide with an anionicity mole charge percentage between 30-70%.

21. The method of claim 18, wherein the predetermined amount of GRAS anionic polymer is between 20-40 ppm.

22. The method of claim 18, wherein the cylindrical mixing chamber has a rotational mixing energy measured in revolutions per minute (RPM) that is a function of its height and its diameter, wherein the height (Ht) is a function of the vertical velocity (VV), the hydraulic retention time (HRT), and the process flow (PF) of the GRAS-treated stillage within the cylindrical mixing chamber.

23. The method of claim 22, wherein the HRT is 60-300 seconds, the VV is 0.01-0.10 feet/second, and the RPM of the GRAS-treated stillage within the cylindrical mixing chamber is between 2 and 5 RPM.

24. The method of claim 18, further comprising recycling the clarified, thin stillage back to a preparation stage of the ethanol production process.

25. The method of claim 18, further comprising the steps of collecting and selling off the dry flocculated solids either as wet distillers grains with solubles (WDGS) or dry distillers grains with solubles (DDGS).

26. The method of claim 18, further comprising extracting oil from the dry flocculated solids.

27. The method of claim 18, wherein the clarified, thin stillage includes spent yeast and further comprising the step of extracting the spent yeast from the clarified, thin stillage using a solids-liquids separator.
